(19) United States
(12) Patent Application Publication
(10) Pub. No.: US 2026/0129329 A1
(43) Pub. Date: May 7, 2026

(54) EARPHONES

(71) Applicant: SHENZHEN SHOKZ CO., LTD., Shenzhen (CN)

(72) Inventors: Chaowu LI, Shenzhen (CN); Chunjian LIU, Shenzhen (CN); Junhao SUI, Shenzhen (CN)

(73) Assignee: SHENZHEN SHOKZ CO., LTD., Shenzhen (CN)

(21) Appl. No.: 19/435,702

(22) Filed: Dec. 29, 2025

Related U.S. Application Data
(63) Continuation of application No. PCT/CN2024/130586, filed on Nov. 7, 2024.

(51) Int. Cl. H04R 1/10

(52) U.S. Cl. CPC H04R 1/1016; H04R 1/105

(57) ABSTRACT

An earphone includes an ear hook and a sound producing assembly connected with the ear hook. The sound producing assembly includes a core housing. The ear hook includes an adapter housing and a hook portion. The adapter housing connects the core housing and the hook portion. The earphone includes a terminal assembly. The core housing has a pressing area. The adapter housing has a bearing area. In a state where the adapter housing is connected with the core housing, the bearing area and the pressing area are stacked. The terminal assembly is disposed between the pressing area and the bearing area, and is clamped by the pressing area and the bearing area. A portion of the terminal assembly is exposed through one or more first through holes in the bearing area.

### CROSS-REFERENCE TO RELATED APPLICATIONS

This application is a continuation of an International Application No. PCT/CN2024/130586, filed on November 7, 2024, the contents of which are hereby incorporated by reference.

### TECHNICAL FIELD

The present disclosure generally relates to the field of electronic devices, and in particular, to an earphone.

### BACKGROUND

With the continuous popularization of electronic devices, the electronic devices have become indispensable social and entertainment tools in daily lives of people. People have increasingly higher requirements for the electronic devices. The electronic devices such as earphones and smart glasses have also been widely used in the daily lives of people. The electronic devices may be used in conjunction with terminal devices such as mobile phones and computers to provide users with an auditory feast.

Currently, Bluetooth earphones usually need to be placed in a charging case. The earphones are usually provided with an exposed terminal assembly electrically connected to a circuit in the charging case, so that the charging case may charge the earphones. However, the terminal assembly provided on the earphone usually requires a support structure for fixation, which occupies space inside the earphone and increases a size of the earphone. Moreover, external impurities such as moisture and dust particles are likely to enter an interior of the earphone from the exposed terminal assembly, damaging components inside the earphone.

### SUMMARY

To solve the above technical problem, one technical solution adopted by the present disclosure is to provide an earphone. The earphone includes an ear hook and a sound producing assembly connected with the ear hook. In a wearing state, the ear hook is hooked between an auricle and a head of a user, and the sound producing assembly is located on an anterior side of the auricle. The sound producing assembly includes a core housing. The ear hook includes an adapter housing and a hook portion. The adapter housing connects the core housing and the hook portion. The earphone includes a terminal assembly. The core housing has a pressing area. The adapter housing has a bearing area. In a state where the adapter housing is connected with the core housing, the bearing area and the pressing area are stacked. The terminal assembly is disposed between the pressing area and the bearing area and is clamped by the pressing area and the bearing area. A portion of the terminal assembly is exposed through one or more first through holes in the bearing area.

In some embodiments, the bearing area is provided with a mounting groove. The one or more first through holes are provided at a bottom of the mounting groove and penetrate the adapter housing. The terminal assembly is pressed by the pressing area into the mounting groove.

In some embodiments, the terminal assembly includes a plurality of electrode terminals and a support plate. The plurality of electrode terminals are arranged at intervals in an array on one side surface of the support plate and are electrically connected with a first wiring through the support plate. The plurality of electrode terminals are connected with a main control circuit board in the core housing through the first wiring. The support plate is mounted in the mounting groove. A count of the one or more first through holes corresponds to a count of the plurality of electrode terminals. A portion of each of the plurality of electrode terminals is exposed through a corresponding first through hole.

In some embodiments, the core housing has a thickness direction. The thickness direction is a direction in which the sound producing assembly faces toward or away from the auricle in the wearing state. An angle between the thickness direction and a stacking direction of the bearing area and the pressing area does not exceed 5°.

In some embodiments, the core housing has a first annular butting edge. The adapter housing has a second annular butting edge. The first annular butting edge and the second annular butting edge are butted against each other. Projections of the bearing area and the pressing area along the stacking direction of the bearing area and the pressing area fall inside the first annular butting edge and the second annular butting edge.

In some embodiments, the core housing has the thickness direction, a width direction, and a length direction that are mutually orthogonal. An installation direction of each of the first annular butting edge and the second annular butting edge forms an angle of less than 5°with the length direction. The core housing has a connection end connecting the ear hook and a free end opposite to the connection end. The length direction is a direction in which the free end and the connection end are spaced apart. The thickness direction is a direction in which the sound producing assembly faces toward or away from the auricle in the wearing state.

In some embodiments, the second annular butting edge is provided with a flange. The flange is engaged with the first annular butting edge along the thickness direction, such that movement of the adapter housing relative to the core housing is restricted in the width direction, the thickness direction, and the length direction.

In some embodiments, the core housing is provided with a card slot along the first annular butting edge. A portion of the flange extends into the card slot and abuts against a wall of the card slot. The card slot is shaped such that movement of the adapter housing relative to the core housing is restricted in a positive direction along the width direction, the thickness direction, and the length direction. The flange is provided with a stop block on a side away from the free end. The stop block abuts against an inner wall of the core housing along the length direction.

In some embodiments, the core housing includes a main bearing portion and an auxiliary connection portion. The pressing area is located on a side of the auxiliary connection portion facing the auricle in the wearing state. The auxiliary connection portion is curved and has at least one end connected to the main bearing portion. An interval channel is formed between the main bearing portion and the auxiliary connection portion. The second annular butting edge is provided with a flange. A portion of the flange passes through the interval channel to engage with the first annular butting edge.

In some embodiments, the earphone includes a speaker assembly disposed inside the core housing and close to the auricle in the wearing state and the main control circuit board disposed on a side of the speaker assembly away from the auricle. The terminal assembly is electrically connected to the main control circuit board via a first wiring. The first wiring passes through the interval channel.

In some embodiments, the speaker assembly includes a main speaker and an auxiliary speaker. The auxiliary speaker is disposed between the auxiliary connection portion and the main speaker. The main bearing portion is provided with a wire hole. The auxiliary speaker is electrically connected to the main control circuit board via a second wiring. The second wiring passes through the wire hole and the interval channel.

In some embodiments, the earphone includes a battery assembly. The battery assembly is disposed in the ear hook. The battery assembly is electrically connected to the main control circuit board via a third wiring. The third wiring passes through the interval channel.

Beneficial effects of the present disclosure are as follows. Different from the prior art, the present disclosure provides the pressing area on the core housing of the sound producing assembly of the earphone and the bearing area on the adapter housing of the ear hook. The terminal assembly is disposed between the pressing area and the bearing area. When the core housing and the adapter housing are connected, the terminal assembly may be clamped by the pressing area and the bearing area to be fixed inside the earphone. Furthermore, a portion of the terminal assembly is exposed through the first through hole of the bearing area. With such a configuration, on one hand, the terminal assembly may be stably fixed inside the earphone merely through the mutual clamping action of the pressing area of the core housing and the bearing area of the adapter housing. There is no need to additionally provide a support structure to fix the terminal assembly, thereby simplifying an internal structure of the earphone, reducing a size of the earphone, and improving a space utilization rate and structural stability inside the earphone. Simultaneously, the mutual clamping action of the pressing area and the bearing area may also allow the terminal assembly to block the first through hole. Therefore, it may also reduce a situation where external impurities such as moisture and dust particles enter the interior of the earphone through the first through hole, thereby reducing a risk of damage and corrosion to components inside the earphone.

### BRIEF DESCRIPTION OF THE DRAWINGS

FIG. 1 is a schematic diagram illustrating an anterior side profile of an ear of a user according to some embodiments of the present disclosure;

FIG. 2 is a schematic diagram illustrating a three-dimensional structure of one side of an embodiment of an earphone according to some embodiments of the present disclosure;

FIG. 3 is a schematic diagram illustrating the earphone embodiment shown in FIG. 2 in a wearing state according to some embodiments of the present disclosure;

FIG. 4 is a schematic diagram illustrating an exploded structure of the earphone embodiment shown in FIG. 2 according to some embodiments of the present disclosure;

FIG. 5 is a schematic diagram illustrating an exploded structure from another perspective of the earphone embodiment shown in FIG. 2 according to some embodiments of the present disclosure;

FIG. 6 is a schematic diagram illustrating a cross-sectional structure along a section line A-A of the earphone embodiment shown in FIG. 2 according to some embodiments of the present disclosure;

FIG. 7 is a schematic diagram illustrating an enlarged local area J of the earphone embodiment shown in FIG. 6 according to some embodiments of the present disclosure;

FIG. 8 is a schematic diagram illustrating a three-dimensional structure from one perspective of a core housing in the earphone embodiment shown in FIG. 2 according to some embodiments of the present disclosure.

### DETAILED DESCRIPTION

The technical solutions in the embodiments of the present disclosure will be clearly and completely described below with reference to the accompanying drawings in the embodiments of the present disclosure. It is apparent that the described embodiments are only a part of the embodiments of the present disclosure, rather than all of the embodiments. All other embodiments obtained by those skilled in the art based on the embodiments of the present disclosure without creative efforts shall fall within the protection scope of the present disclosure.

The mention of “embodiment” in the present disclosure means that a specific feature, structure, or characteristic described in connection with the embodiment may be included in at least one embodiment of the present disclosure. Those skilled in the art explicitly and implicitly understands that the embodiments described in the present disclosure may be combined with other embodiments.

The following is an exemplary description of an earphone in an earphone embodiment.

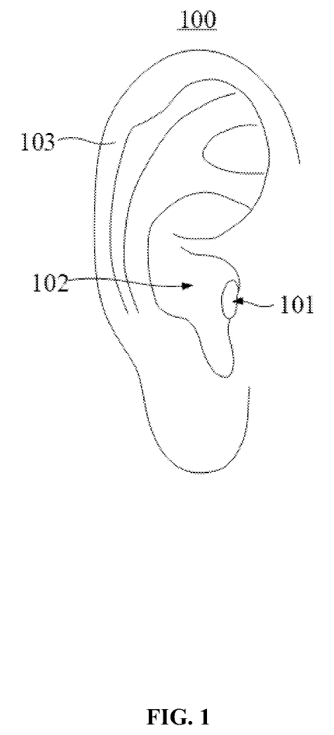

With reference to FIG. 1, an ear 100 of a user may include physiological parts such as an external ear canal 101, a concha cavity 102, and an auricle 103, etc. Although the external ear canal 101 has a certain depth and extends to a tympanic membrane of the ear 100, for ease of description, the external ear canal 101 in the present disclosure refers to an entrance of the ear facing away from the tympanic membrane (i.e., an ear hole) unless otherwise specified. In addition, the concha cavity 102 has a certain volume and depth, and the concha cavity 102 is directly connected to the external ear canal 101, i.e., the aforementioned ear hole may be simply regarded as being located at a bottom of the concha cavity 102.

An earphone 1 is an audio converter capable of receiving an electrical signal from a media player or a receiver and converting the electrical signal into a sound wave that a user is able to hear. In some embodiments, the earphone 1 is an open earphone, e.g., an ear-hook earphone, a rear-hanging earphone, or an ear-clip earphone.

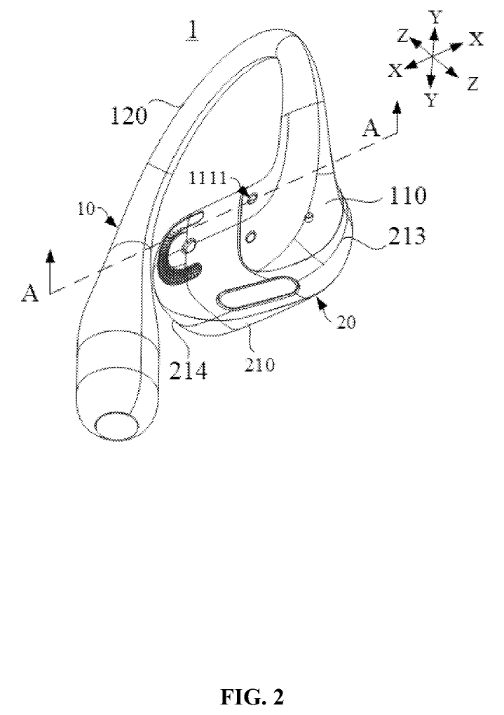

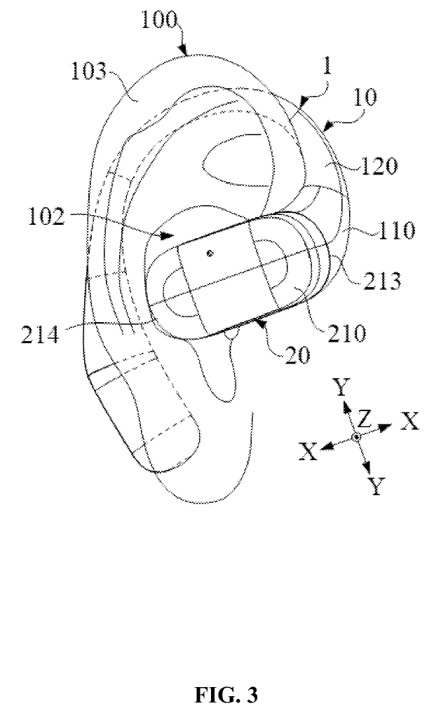

As shown in FIG. 2 or FIG. 3, the earphone 1 may be the ear-hook earphone. In some embodiments, in a wearing state, at least a portion of the earphone 1 may be inserted into the concha cavity 102 of the user to improve a wearing stability. In some embodiments, at least a portion of a sound producing assembly 20 of the earphone 1 covers at least a part of the auricle 103 of a user’s ear, e.g., an antihelix, a cymba conchae, or a triangular fossa (not shown in the figure), without obstructing the external ear canal 101 of the user’s ear or visually shielding the external ear canal 101 of the user’s ear. In some embodiments, the sound producing assembly 20 of the earphone 1 may conform against or abut a facial area in front of the user’s ear, and a side of the sound producing assembly 20 for producing sound faces the user’s ear or orients toward the external ear canal 101 of the user.

Furthermore, different users may have individual differences, resulting in dimensional differences such as different shapes and sizes of the ear 100. For ease of description and to reduce (or even eliminate) individual differences of different users, a simulator including a head and ears 100 (left and right) thereof is manufactured based on ANSI: S3.36, S3.25 and IEC: 60318-7 standards, e.g., GRAS 45BC KEMAR, HEAD Acoustics, B&K 4128 series, or B&K 5128 series, to present a scenario where most users wear the earphone 1. Taking GRAS KEMAR as an example, the simulator of the ear 100 may be any one of GRAS 45AC, GRAS 45BC, GRAS 45CC, or GRAS 43AG, etc. Taking HEAD Acoustics as an example, the simulator of the ear 100 may be any one of HMS II.3, HMS II.3 LN, or HMS II.3LN HEC, etc. Therefore, in the present disclosure, descriptions such as “a user wears the earphone 1”, “the earphone 1 is in a wearing state”, and “in a wearing state” may refer to the earphone 1 described in the present disclosure being worn on the ear 100 of the aforementioned simulator. Certainly, precisely because different users have individual differences, when the earphone 1 is worn by different users, there may be certain differences from the earphone 1 being worn on the ear 100 of the aforementioned simulator, but such differences should be tolerated.

It should be noted that in fields such as medicine and anatomy, three basic planes, namely a sagittal plane, a coronal plane, and a horizontal plane, and three basic axes, namely a sagittal axis, a coronal axis, and a vertical axis, may be defined for a human body or a human body simulator. The sagittal plane refers to a plane made along an anteroposterior direction of the body and perpendicular to the ground, which divides the human body or the human body simulator into left and right parts. The coronal plane refers to a plane made along a left-right direction of the body and perpendicular to the ground, which divides the human body or the human body simulator into front and rear parts. The horizontal plane refers to a plane made along a superior-inferior direction of the body and parallel to the ground, which divides the human body or the human body simulator into upper and lower parts. Correspondingly, the sagittal axis refers to an axis along the anteroposterior direction of the body and perpendicular to the coronal plane. The coronal axis refers to an axis along the left-right direction of the body and perpendicular to the sagittal plane. The vertical axis refers to an axis along the superior-inferior direction of the body and perpendicular to the horizontal plane. Furthermore, the “front side of the ear” described in the present disclosure is a concept relative to the “rear side of the ear.” The “front side of the ear” refers to a side of the ear facing away from the head, and the “rear side of the ear” refers to a side of the ear facing toward the head. Both the “front side of the ear” and the “rear side of the ear” are directed to the ear 100 of the user or the simulator. When observing the ear 100 of the human body or the human body simulator along a direction of the coronal axis, it may be as shown in FIG. 1.

Merely by way of example, with reference to FIG. 2 and FIG. 3, the earphone 1 includes an ear hook 10 and the sound producing assembly 20 connected with the ear hook 10. In the wearing state, the ear hook 10 may be hooked between the auricle 103 and the head of the user, i.e., at least a portion of the ear hook 10 of the earphone 1 may be located at the rear side of the ear 100, so that the earphone 1 is hooked on the ear 100, and the sound producing assembly 20 may be located at the front side of the auricle 103. The sound producing assembly 20 may be a sound playback device. The sound producing assembly 20 may be configured to convert the electrical signal into a sound signal (which may also be referred to as the “sound wave” or the “sound signal”) and propagate the sound signal to the ear 100 of a wearer.

In some embodiments, a battery, a circuit board, or other components is disposed in the ear hook 10, or both the battery and the circuit board are disposed in the ear hook 10. Certainly, the ear hook 10 may also not be provided with components such as the battery and the circuit board, and the components such as the battery and the circuit board may be installed in the sound producing assembly 20.

In some embodiments, as shown in FIG. 2 and FIG. 3, the sound producing assembly 20 includes a core housing 210. In some embodiments, the earphone 1 further includes a speaker assembly 30 disposed in the core housing 210. The speaker assembly 30 is a component capable of converting the electrical signal into the corresponding sound signal to realize a sound playback function of the sound producing assembly 20. Merely by way of example, the speaker assembly 30 may include a bone conduction speaker and an air conduction speaker. In other embodiments, the speaker assembly 30 may be one of the air conduction speaker and the bone conduction speaker.

In some embodiments, as shown in FIG. 2 and FIG. 3, the ear hook 10 includes an adapter housing 110 and a hook portion 120. The adapter housing 110 may be configured to connect the core housing 210 and the hook portion 120. The hook portion 120 presents a hook shape for hooking on the ear 100 of the user when the user wears the earphone 1.

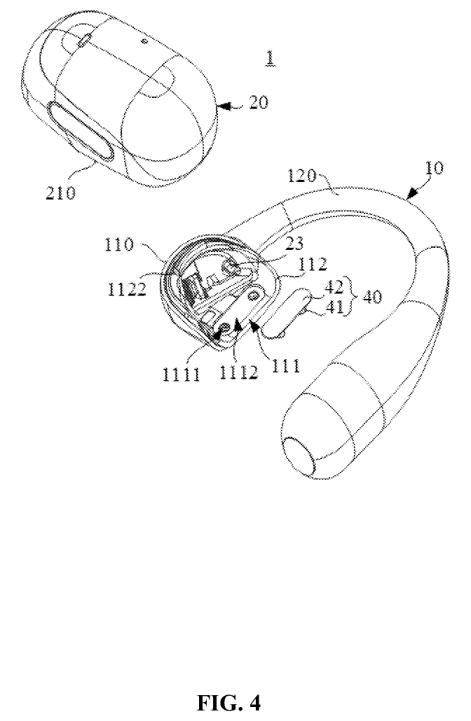

In some embodiments, as shown in FIGS. 4-7, the earphone 1 may include a terminal assembly 40 and a main control circuit board 50. The core housing 210 has a pressing area 211. The adapter housing 110 has a bearing area 111. In a state where the adapter housing 110 is connected with the core housing 210, the bearing area 111 and the pressing area 211 are stacked. The terminal assembly 40 is disposed between the pressing area 211 and the bearing area 111 and is clamped by the pressing area 211 and the bearing area 111. A portion of the terminal assembly 40 is exposed through one or more first through holes 1111 in the bearing area 111.

The terminal assembly 40 includes an electrode terminal 41. A portion of the electrode terminal 41 may be exposed to an outer surface of the adapter housing 110 of the earphone 1 through a corresponding first through hole 1111, and another portion is electrically connected to the main control circuit board 50, so that the earphone 1 may be electrically connected to an internal circuit of a charging case through the terminal assembly 40, thereby enabling the charging case to charge the earphone 1 through the terminal assembly 40.

In some embodiments, the terminal assembly 40 may further include a detection terminal (not shown in the figure). The detection terminal facilitates the earphone 1 to implement a detection function such as charging detection, detection of the earphone 1 being placed into or taken out of the charging case, etc.

Specifically, when the core housing 210 is connected with the adapter housing 110, the terminal assembly 40 is clamped by the pressing area 211 and the bearing area 111 to be fixed inside the earphone 1, and a portion of the terminal assembly 40 is exposed through the one or more first through holes 1111 of the bearing area 111. With such a configuration, on one hand, the terminal assembly 40 may be stably fixed inside the earphone 1 merely through the mutual clamping action of the pressing area 211 of the core housing 210 and the bearing area 111 of the adapter housing 110. There is no need to additionally provide a support structure to stably fix the terminal assembly 40, thereby simplifying the internal structure of the earphone 1, reducing the assembly difficulty of the earphone 1, reducing the size of the earphone 1, and improving the space utilization rate and structural stability inside the earphone 1. Simultaneously, the terminal assembly 40 may block the one or more first through holes 1111 under the action of the pressing area 211 and the bearing area 111, thereby reducing a risk of external impurities such as moisture and dust particles entering the inside of the earphone 1 through the one or more first through holes 1111, and reducing the risk of damage and corrosion to components inside the earphone 1.

In some embodiments, as shown in FIG. 4, the bearing area 111 may be provided with a mounting groove 1112. The one or more first through holes 1111 are provided at a bottom portion of the mounting groove 1112 and penetrate the adapter housing 110. The terminal assembly 40 may be pressed by the pressing area 211 into the mounting groove 1112. With such a configuration, the mounting groove 1112 may be used to limit the terminal assembly 40, to further limit freedom degrees of the terminal assembly 40 in directions other than a pressing direction, reduce a risk of unstable electrical connection caused by movement of the terminal assembly 40, and improve a charging efficiency of the earphone 1.

In some embodiments, as shown in FIG. 4, the terminal assembly 40 may include a plurality of electrode terminals 41 and a support plate 42. The plurality of electrode terminals 41 may be arranged at intervals in an array on one side surface of the support plate 42 and are electrically connected with a first wiring 21 through the support plate 42, and the plurality of electrode terminals 41 are connected with the main control circuit board 50 in the core housing 210 through the first wiring 21. The first wiring 21 may be a flexible circuit board, a wire, or another structure or module capable of transmitting current. A count of the one or more first through holes 1111 corresponds to a count of the plurality of electrode terminals 41. A portion of each of the plurality of electrode terminals 41 is exposed through a corresponding first through hole 1111. Fixing the plurality of electrode terminals 41 by using the support plate 42 may enable the plurality of electrode terminals 41 to be arranged regularly and evenly, ensuring consistency and stability of electrical connection. The support plate 42 may be entirely made of a conductive metal material or a plastic materials, or a portion of the support plate 42 may be made of the conductive metal material and another portion may be made of a non-conductive plastic material.

Specifically, the support plate 42 is mounted in the mounting groove 1112. The shape of the mounting groove 1112 and the position and shape of the first through hole 1111 may be adapted to the shape of the terminal assembly 40, so as to facilitate placement of the terminal assembly 40 on the bearing area 111, thereby improving the assembly convenience of the terminal assembly 40.

The core housing 210 may have a thickness direction. The thickness direction is a direction in which the sound producing assembly 20 faces toward or away from the auricle 103 in the wearing state. An angle between the thickness direction and a stacking direction of the bearing area 111 and the pressing area 211 does not exceed 5°.

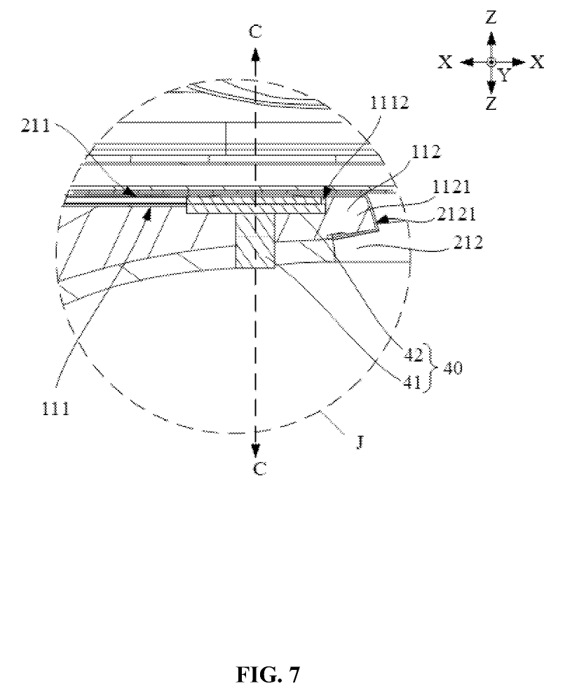

Merely by way of example, the stacking direction of the bearing area 111 and the pressing area 211 may be a direction indicated by an arrow C in FIG. 7, and the thickness direction may be a direction indicated by an arrow Z in FIG. 7. Merely by way of example, the angle between the thickness direction Z and the stacking direction C of the bearing area 111 and the pressing area 211 may be 0°, 1°, 2.5°, 4°, or 4.5°, etc.

If the angle between the thickness direction Z and the stacking direction C of the bearing area 111 the pressing area 211 is set to exceed 5°, the bearing area 111, the pressing area 211, and the terminal assembly 40 may occupy a large space in the thickness direction Z. Moreover, an excessively inclined setting of the stacking direction C of the bearing area 111 and the pressing area 211 relative to the thickness direction Z may also increase the lateral force on the terminal assembly 40, increase the installation difficulty of the terminal assembly 40, and affect the service life of the terminal assembly 40.

Therefore, setting the angle between the thickness direction Z and the stacking direction C of the bearing area 111 the pressing area 211 to not exceed 5° may not only reduce the space occupied by the bearing area 111, the pressing area 211, and the terminal assembly 40 in the thickness direction Z, and reduce the size of the earphone 1 in the thickness direction Z, but also reduce the installation difficulty of the terminal assembly 40.

In some embodiments, as shown in FIGS. 4-7, the core housing 210 has a first annular butting edge 212, and the adapter housing 110 has a second annular butting edge 112. When the core housing 210 and the adapter housing 110 are connected, the first annular butting edge 212 and the second annular butting edge 112 may be butted against each other. Projections of the bearing area 111 and the pressing area 211 along the stacking direction may fall inside the first annular butting edge 212 and the second annular butting edge 112.

Specifically, each of the first annular butting edge 212 and the second annular butting edge 112 may present an irregular annular structure. The core housing 210 and the adapter housing 110 may be fixedly butted against each other through the first annular butting edge 212 and the second annular butting edge 112. With such a configuration, the connection and fixation structure between the core housing 210 and the adapter housing 110 may be simplified. The annular butting structures may also make the connection between the ear hook 10 and the sound producing assembly 20 more stable, thereby improving the structural stability of the earphone 1.

Furthermore, since the first annular butting edge 212 and the second annular butting edge 112 are butted against each other, the bearing area 111 and the pressing area 211 also press against each other in the stacking direction. Therefore, a pressure generated by the butting of the first annular butting edge 212 and the second annular butting edge 112 affects a pressing pressure between the bearing area 111 and the pressing area 211 in the stacking direction. Therefore, in the stacking direction of the bearing area 111 and the pressing area 211, setting the projections of the bearing area 111 and the pressing area 211 along the stacking direction to fall inside the first annular butting edge 212 and the second annular butting edge 112 may strengthen the pressing pressure of the bearing area 111 and the pressing area 211 against each other in the stacking direction C, so that the bearing area 111 and the pressing area 211 may strengthen a clamping force on the terminal assembly 40, making the terminal assembly 40 more stable, thereby improving compactness and stability of the internal structure of the earphone 1.

In some embodiments, as shown in FIGS. 2-3, the core housing 210 may have the thickness direction, a width direction, and a length direction that are mutually orthogonal. The core housing 210 has a connection end 213 connecting the ear hook 10 and a free end 214 opposite to the connection end 213. In the wearing state, at least a portion of the free end 214 may extend into the concha cavity 102 or abut against the auricle 103 of the user.

The length direction may be a spacing direction between the connection end 213 and the free end 214. The spacing direction between the connection end 213 and the free end 214 refers to an extension direction of a line connecting the connection end 213 and the free end 214. In some embodiments, the connection end 213 and the free end 214 may be irregular or regular arcs. The extension direction of the line connecting the connection end 213 and the free end 214 may refer to a direction defined by a straight line perpendicular to parallel tangent planes of two reference points on the connection end 213 and the free end 214 that are farthest apart from each other. The length direction may also be defined as a direction in which the core housing 210 approaches or moves away from a back of the head in the wearing state, i.e., a direction defined between a side surface of the core housing 210 close to the back of the head and a side surface of the core housing 210 away from the back of the head in the wearing state. Merely by way of example, the length direction may be a direction indicated by an arrow X in FIGS. 2-7. It should be noted that the length direction, the width direction, and the thickness direction of the core housing 210 defined using the wearing state in the present disclosure are all based on a coordinate system with the core housing 210 as a reference. The coordinate system is independent of the three basic axes of the human body and does not change due to slight differences when worn on different user’s ears.

The width direction may be defined as a direction in which the core housing 210 approaches or moves away from a top of the head in the wearing state, i.e., a direction defined between a side surface of the core housing 210 close to the top of the head and a side surface of the core housing 210 away from the top of the head in the wearing state. Merely by way of example, the width direction may be a direction indicated by an arrow Y in FIGS. 2 -7. The thickness direction Z, the width direction Y, and the length direction X are perpendicular to each other.

In some embodiments, an angle formed by an installation direction of the first annular butting edge 212 and the second annular butting edge 112 with the length direction X may be less than 5°.

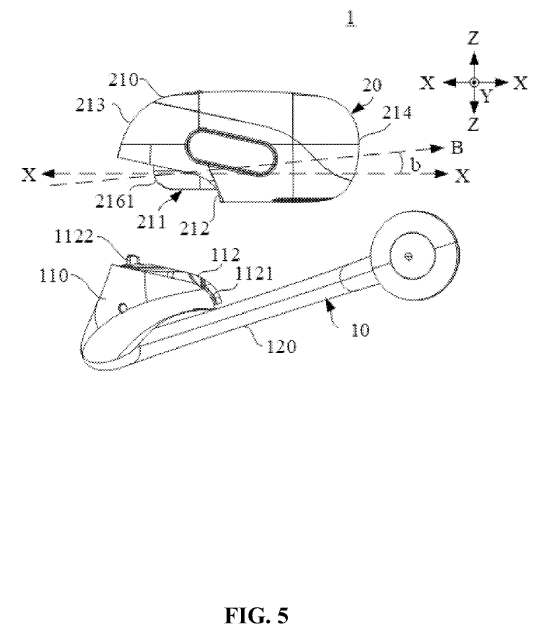

Merely by way of example, the installation direction of the first annular butting edge 212 and the second annular butting edge 112 may be a direction indicated by an arrow B in FIG. 5. The angle formed by the installation direction B of the first annular butting edge 212 and the second annular butting edge 112 with the length direction X is shown as an angle b in FIG. 5. Merely by way of example, the angle formed by the installation direction B of the first annular butting edge 212 and the second annular butting edge 112 with the length direction X may be 1°, 2°, 2.5°, 3°, 4°, 4.5°, or other values.

Setting the angle formed by the installation direction B of the first annular butting edge 212 and the second annular butting edge 112 with the length direction X to be less than 5° may increase a contact area between the first annular butting edge 212 and the second annular butting edge 112, reduce interference between the second annular butting edge 112 and the core housing 210 during installation, affect assembly consistency, and make the connection between the adapter housing 110 and the core housing 210 more stable. Moreover, setting the installation direction B of the first annular butting edge 212 and the second annular butting edge 112 to be more toward the length direction X may allow the bearing area 111 and the pressing area 211 to gradually apply the pressing force to the terminal assembly 40, reducing situations where the pressing area 211 directly impacts the terminal assembly 40 and causes damage to the terminal assembly 40.

In some embodiments, the first annular butting edge 212 and the second annular butting edge 112 may be engaged through an interference fit. In some embodiments, a viscous medium may be filled between opposing surfaces of the first annular butting edge 212 and the second annular butting edge 112 to enhance the stability of the connection between the first annular butting edge 212 and the second annular butting edge 112.

In some embodiments, as shown in FIGS. 5-7, the second annular butting edge 112 may be provided with a flange 1121. The flange 1121 may be engaged with the first annular butting edge 212 along the thickness direction Z, such that movement of the adapter housing 110 relative to the core housing 210 is restricted in the width direction Y, the thickness direction Z, and the length direction X, to enhance a connection strength between the first annular butting edge 212 and the second annular butting edge 112, further increase the pressing force applied by the bearing area 111 and the pressing area 211 to the terminal assembly 40, make installation of the terminal assembly 40 more secure, and simultaneously improve the seal of the earphone 1.

The shape of the flange 1121 provided on the second annular butting edge 112 may correspond to the first annular butting edge 212. In some embodiments, the flange 1121 may be in an annular shape, and the annular flange 1121 is provided on a side of the second annular butting edge 112 facing the interior of the core housing 210. The first annular butting edge 212 abuts against the side of the flange 1121 that face the exterior of the adapter housing 110, so that movement of the adapter housing 110 relative to the core housing 210 is restricted in the width direction Y, the thickness direction Z, and the length direction X. With such a configuration, the strength of the flange 1121 may be increased, reducing situations where the flange 1121 breaks during installation and affects the connection strength between the first annular butting edge 212 and the second annular butting edge 112.

In some embodiments, the core housing 210 may be provided with a card slot 2121 along the first annular butting edge 212. The shape of the card slot 2121 may correspond to the flange 1121. When the first annular butting edge 212 and the second annular butting edge 112 are butted against each other, a portion of the flange 1121 may extend into the card slot 2121 and abut against a wall of the card slot 2121. The card slot 2121 is shaped such that movement of the adapter housing 110 relative to the core housing 210 is restricted in a positive direction along the width direction Y, the thickness direction Z, and the length direction X.

Specifically, during an assembly process of the adapter housing 110 and the core housing 210, a portion of the flange 1121 may extend into the card slot 2121 along the installation direction B, thereby allowing the first annular butting edge 212 to limit the position of the flange 1121. In other words, the installation direction B is a direction in which the portion of the flange 1121 may extend into the card slot 2121 during the assembly process of the adapter housing 110 and the core housing 210.

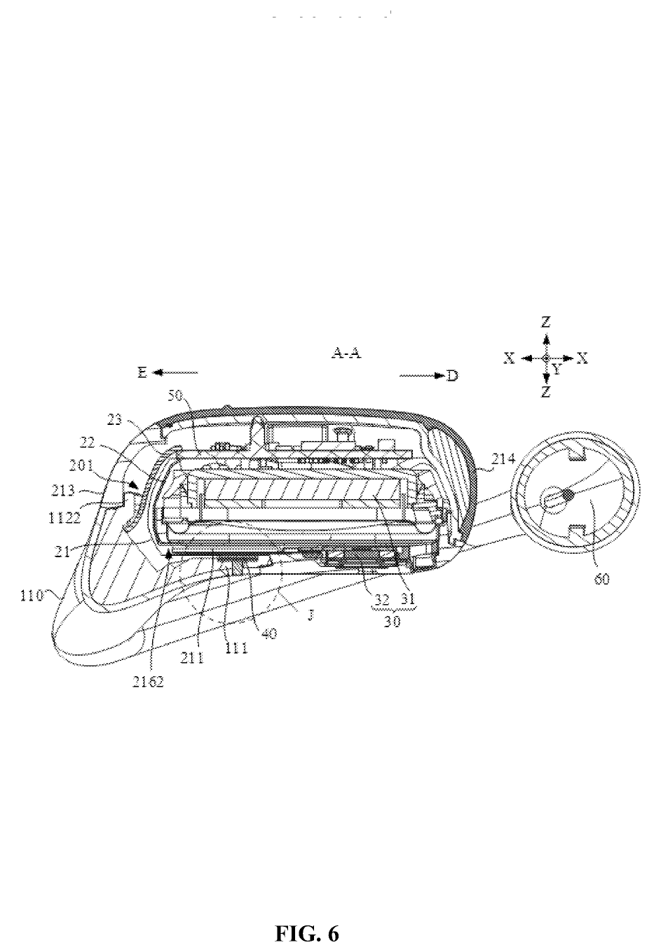

In some embodiments, as shown in FIGS. 5-6, the flange 1121 is provided with a stop block 1122 on a side away from the free end 214. The stop block 1122 abuts against an inner wall of the core housing 210 along the length direction X. The stop block 1122 may be opposite to the card slot 2121 in the length direction X. A side of the stop block 1122 away from the card slot 2121 along the length direction X abuts against the inner wall of the core housing 210, so that the card slot 2121 may restrict the movement of the adapter housing 110 in the positive direction along the length direction X, and the core housing 210 may restrict movement of the adapter housing 110 in a negative direction along the length direction X by restricting the stop block 1122. Merely by way of example, the positive direction of the length direction X may be a direction indicated by an arrow D in the figures, and the negative direction of the length direction X may be a direction indicated by an arrow E in the figures.

With such a configuration, the connection between the first annular butting edge 212 and the second annular butting edge 112 may be tighter, making it less likely for the adapter housing 110 and the core housing 210 to become loose relative to each other, thereby further increasing the pressing force applied by the bearing area 111 and the pressing area 211 to the terminal assembly 40.

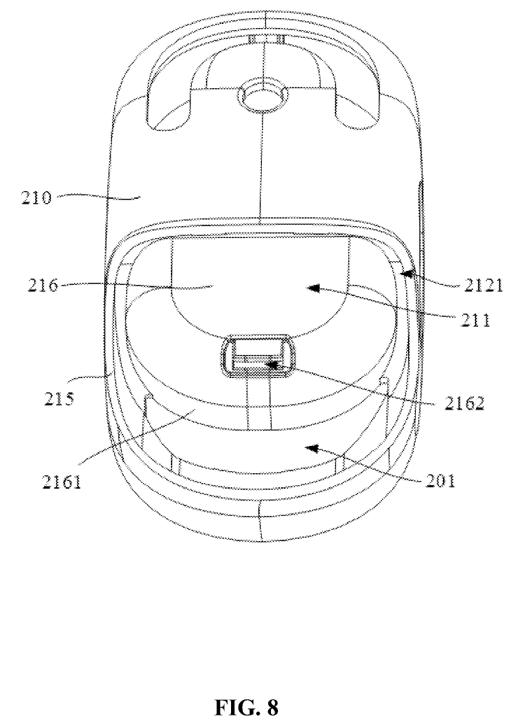

In some embodiments, as shown in FIG. 8, the core housing 210 may include a main bearing portion 215 and an auxiliary connection portion 216. The pressing area 211 is located on a side of the auxiliary connection portion 216 facing the auricle 103 in the wearing state.

The pressing area 211 is disposed on the side of the auxiliary connection portion 216 facing the auricle 103 in the wearing state. Since the angle between the stacking direction C of the pressing area 211 and the bearing area 111 and the thickness direction Z of the core housing 210 does not exceed 5°, in the wearing state, the terminal assembly 40 exposed from the one or more first through holes 1111 of the bearing area 111 may be blocked by a user, which makes the terminal assembly 40 less susceptible to damage from scraping or impact, and also improves aesthetic appearance of the earphone 1.

A portion of the auxiliary connection portion 216 is curved and has at least one end connected with the main bearing portion 215. An interval channel 201 is formed between the main bearing portion 215 and the auxiliary connection portion 216. The second annular butting edge 112 may be provided with the flange 1121. A portion of the flange 1121 passes through the interval channel 201 to engage with the first annular butting edge 212.

In some embodiments, the flange 1121 may be provided with the stop block 1122. The stop block 1122 passes through the interval channel 201 and abuts against the inner wall of the core housing 210, and is engaged with the first annular butting edge 212. Specifically, during assembly of the adapter housing 110 and the core housing 210, a portion of the flange 1121 may extend into the card slot 2121 along the installation direction B. The stop block 1122 may then pass through the interval channel 201 along the thickness direction Z to abut against the inner wall of the core housing 210, thereby achieving engagement between the first annular butting edge 212 and the second annular butting edge 112.

In some embodiments, the main bearing portion 215 and the auxiliary connection portion 216 may be integrally formed, which may enhance the connection strength between the main bearing portion 215 and the auxiliary connection portion 216, and improve the overall strength of the core housing 210.

In some embodiments, as shown in FIGS. 5 and 8, the auxiliary connection portion 216 may include the pressing area 211 and a curved area 2161. The pressing area 211 has a flat plate configuration, and one end of the pressing area 211 is connected with the main bearing portion 215. One side of the curved area 2161 is connected with the pressing area 211, and another side of the curved area 2161 is curved and extends toward an interior of the core housing 210 along the thickness direction Z. The interval channel 201 is formed between a portion of the first annular butting edge 212 and the curved area 2161.

In some embodiments, as shown in FIG. 6, the earphone 1 may include the speaker assembly 30 disposed inside the core housing 210 and close to the auricle 103 in the wearing state, and a main control circuit board 50 disposed on a side of the speaker assembly 30 away from the auricle 103.

Further, the speaker assembly 30 may be disposed on a side of the auxiliary connection portion 216 away from the auricle 103. A portion of the speaker assembly 30 may be placed on a side of the pressing area 211 away from the adapter housing 110. The curved area 2161 may restrict movement of the speaker assembly 30 toward a negative direction E of the length direction X, thereby limiting the position of the speaker assembly 30.

In some embodiments, as shown in FIG. 6, the terminal assembly 40 is electrically connected to the main control circuit board 50 via the first wiring 21. The first wiring 21 passes through the interval channel 201.

The main control circuit board 50 refers to a core control portion inside the earphone 1. The main control circuit board 50 may be a printed circuit board (PCB), a flexible printed circuit board (FPC), or other types of circuit boards. The main control circuit board 50 may be electrically connected with the speaker assembly 30 and the terminal assembly 40.

The first wiring 21 may be an electrical conductor, a flexible circuit board, or other structure or modules capable of transmitting electric current. The terminal assembly 40 is electrically connected with the main control circuit board 50 via the first wiring 21. Specifically, one end of the first wiring 21 may be connected with the terminal assembly 40, and another end of the first wiring 21 may pass through the interval channel 201, extend into the interior of the core housing 210, and connect with the main control circuit board 50. With such a configuration, the routing of the first wiring 21 may be organized via the interval channel 201. The first wiring 21 may extend along or abut against an inner wall of the interval channel 201, i.e., a portion of a curved wall of the auxiliary connection portion 216, which prevents excessive bending of the first wiring 21 along its extension path, reduces a risk of damage, improves the service life of the first wiring 21, and enables the auxiliary connection portion 216 to be functionally multiplexed.

In some embodiments, as shown in FIG. 6, the speaker assembly 30 may include a main speaker 31 and an auxiliary speaker 32. The auxiliary speaker 32 may be disposed between the auxiliary connection portion 216 and the main speaker 31, i.e., on a side of the main speaker 31 away from the main control circuit board 50. As shown in FIG. 8, the auxiliary connection portion 216 is provided with a wire hole 2162. The auxiliary speaker 32 is electrically connected with the main control circuit board 50 via a second wiring 22. The second wiring 22 passes through the wire hole 2162 and the interval channel 201.

The main speaker 31 and the auxiliary speaker 32 may be air conduction speakers. The second wiring 22 may be an electrical conductor, a flexible circuit board, or other structures or modules capable of transmitting electric current. With such a configuration, it is convenient to achieve a long-distance electrical connection between the auxiliary speaker 32 and the main control circuit board 50. By passing the second wiring 22 through the wire hole 2162 and the interval channel 201, the second wiring 22 may extend along wall surfaces of the core housing 210 and the auxiliary connection portion 216, which allows the auxiliary connection portion 216 and the core housing 210 to organize a routing of the second wiring 22, prevents excessive bending of the second wiring 22 along the extension path, reduces the risk of damage, and provides slack. Therefore, a likelihood of breakage due to prolonged vibration of the auxiliary speaker 32 is reduced, thereby ensuring the normal output from the auxiliary speaker 32 and improving the listening experience of the user.

In some embodiments, the wire hole 2162 may be disposed between the pressing area 211 and the curved area 2161. A position of the wire hole 2162 may correspond to a position of the auxiliary speaker 32. One end of the second wiring 22 is connected with the auxiliary speaker 32. Another end of the second wiring 22 extends along a wall surface of the pressing area 211 facing the interior of the core housing 210, passes through the wire hole 2162, further passes through the interval channel 201, and is electrically connected with the main control circuit board 50 located on a side of the main speaker 31 away from the auxiliary speaker 32.

With such a configuration, it is convenient to achieve an electrical connection between the auxiliary speaker 32 and the main control circuit board 50. Furthermore, the interval channel 201 and the wire hole 2162 may organize the routing of the second wiring 22 and secure the second wiring 22, making internal wiring of the earphone 1 neater and more organized.

In some embodiments, as shown in FIGS. 4 and 6, the earphone 1 includes a battery assembly 60. The battery assembly 60 may be disposed in the ear hook 10. The battery assembly 60 is electrically connected with the main control circuit board 50 via a third wiring 23. The third wiring 23 passes through the interval channel 201.

The third wiring 23 is an electrical conductor, a flexible circuit board, or other structures or modules capable of transmitting electric current. One end of the third wiring 23 may be connected with the battery assembly 60 in the ear hook 10. Another end of the third wiring 23 extends along the hook portion 120 into the adapter housing 110, passes through the interval channel 201, and is electrically connected with the main control circuit board 50 in the core housing 210, thereby enabling the battery assembly 60 in the ear hook 10 to supply power to components in the sound producing assembly 20 via the third wiring 23.

Disposing the battery assembly 60 in the ear hook 10 may reduce a size of the sound producing assembly 20 and improve the space utilization rate of the earphone 1. Furthermore, the third wiring 23 extends along the hook portion 120 and the interval channel 201 further into the interior of the core housing 210 to electrically connect with the main control circuit board 50, which facilitates the electrical connection between the battery assembly 60 and the main control circuit board 50, reduces redundancy of the third wiring 23, and makes the third wiring 23 more organized.

In summary, according to some embodiments of the present disclosure, the earphone 1 has the core housing 210 of the sound producing assembly 20 that includes the pressing area 211. The adapter housing 110 of the ear hook 10 includes the bearing area 111. The terminal assembly 40 is disposed between the pressing area 211 and the bearing area 111. When the core housing 210 and the adapter housing 110 are connected, the terminal assembly 40 is clamped by the pressing area 211 and the bearing area 111 to be fixed inside the earphone 1. Furthermore, a portion of the terminal assembly 40 is exposed through the first through hole 1111 of the bearing area 111. With such a configuration, on one hand, the terminal assembly 40 may be stably fixed inside the earphone 1 merely by the mutual clamping action of the pressing area 211 of the core housing 210 and the bearing area 111 of the adapter housing 110. There is no need to additional provide a support structure to fix the terminal assembly 40, thereby simplifying the internal structure of the earphone 1, reducing the size of the earphone 1, and improving the internal space utilization rate and structural stability inside the earphone 1. Simultaneously, the mutual clamping action of the pressing area 211 and the bearing area 111 also allow the terminal assembly 40 to block the first through hole 1111. Therefore, it may also reduce a situation where external impurities such as moisture and dust particles enter the interior of the earphone 1 through the first through hole 1111, thereby reducing the risk of damage and corrosion to components inside the earphone 1.

The foregoing embodiments are merely illustrative and are not intended to limit a patent protection scope of the present disclosure. Any equivalent structure or equivalent process transformation made based on the content of the present disclosure and the accompanying drawings, or direct or indirect application in other related technical fields, shall similarly be included within the patent protection scope of the present disclosure.

What is claimed is:

1. An earphone, comprising:
an ear hook, a sound producing assembly connected with the ear hook, and a terminal assembly, wherein
in a wearing state, the ear hook is hooked between an auricle and a head of a user, the sound producing assembly is located on an anterior side of the auricle, the sound producing assembly comprises a core housing, the ear hook comprises an adapter housing and a hook portion, the adapter housing connects the core housing and the hook portion;
the core housing has a pressing area, the adapter housing has a bearing area, and in a state where the adapter housing is connected with the core housing, the bearing area and the pressing area are stacked, the terminal assembly is disposed between the pressing area and the bearing area and is clamped by the pressing area and the bearing area, and a portion of the terminal assembly is exposed through one or more first through holes in the bearing area.

2. The earphone according to claim 1, wherein the bearing area is provided with a mounting groove, the one or more first through holes are provided at a bottom of the mounting groove and penetrate the adapter housing, and the terminal assembly is pressed by the pressing area into the mounting groove.

3. The earphone according to claim 2, wherein the terminal assembly comprises a plurality of electrode terminals and a support plate, the plurality of electrode terminals are arranged at intervals in an array on one side surface of the support plate and are electrically connected with a first wiring through the support plate, and the plurality of electrode terminals are connected with a main control circuit board in the core housing through the first wiring, the support plate is mounted in the mounting groove, a count of the one or more first through holes corresponds to a count of the plurality of electrode terminals, and a portion of each of the plurality of electrode terminals is exposed through a corresponding first through hole.

4. The earphone according to claim 1, wherein the core housing has a thickness direction, which is a direction in which the sound producing assembly faces toward or away from the auricle in the wearing state, and an angle between the thickness direction and a stacking direction of the bearing area and the pressing area does not exceed 5°.

5. The earphone according to claim 1, wherein the core housing has a first annular butting edge, the adapter housing has a second annular butting edge, the first annular butting edge and the second annular butting edge are butted against each other, and projections of the bearing area and the pressing area along a stacking direction of the bearing area and the pressing area fall inside the first annular butting edge and the second annular butting edge.

6. The earphone according to claim 5, wherein the core housing has a thickness direction, a width direction, and a length direction that are mutually orthogonal, an installation direction of each of the first annular butting edge and the second annular butting edge forms an angle of less than 5° with the length direction, the core housing has a connection end connecting the ear hook and a free end opposite to the connection end, the length direction is a direction in which the free end and the connection end are spaced apart, and the thickness direction is a direction in which the sound producing assembly faces toward or away from the auricle in the wearing state.

7. The earphone according to claim 6, wherein the second annular butting edge is provided with a flange, the flange is engaged with the first annular butting edge along the thickness direction, such that movement of the adapter housing relative to the core housing is restricted in the width direction, the thickness direction, and the length direction.

8. The earphone according to claim 7, wherein the core housing is provided with a card slot along the first annular butting edge, a portion of the flange extends into the card slot and abuts against a wall of the card slot, the card slot is shaped such that movement of the adapter housing relative to the core housing is restricted in a positive direction along the width direction, the thickness direction, and the length direction, and the flange is provided with a stop block on a side away from the free end, the stop block abuts against an inner wall of the core housing along the length direction.

9. The earphone according to claim 5, wherein the core housing comprises a main bearing portion and an auxiliary connection portion, the pressing area is located on a side of the auxiliary connection portion facing the auricle in the wearing state, the auxiliary connection portion is partially curved and has at least one end connected to the main bearing portion, an interval channel is formed between the main bearing portion and the auxiliary connection portion, the second annular butting edge is provided with a flange, and a portion of the flange passes through the interval channel to engage with the first annular butting edge.

10. The earphone according to claim 9, wherein the earphone comprises a speaker assembly disposed inside the core housing and close to the auricle in the wearing state, and a main control circuit board disposed on a side of the speaker assembly away from the auricle, the terminal assembly is electrically connected to the main control circuit board via a first wiring, and the first wiring passes through the interval channel.

11. The earphone according to claim 10, wherein the speaker assembly comprises a main speaker and an auxiliary speaker, the auxiliary speaker is disposed between the auxiliary connection portion and the main speaker, the auxiliary connection portion is provided with a wire hole, the auxiliary speaker is electrically connected to the main control circuit board via a second wiring, and the second wiring passes through the wire hole and the interval channel.

12. The earphone according to claim 10, wherein the earphone comprises a battery assembly, the battery assembly is disposed in the ear hook, the battery assembly is electrically connected to the main control circuit board via a third wiring, and the third wiring passes through the interval channel.

13. The earphone according to claim 1, wherein the earphone includes a main control circuit board, the terminal assembly includes an electrode terminal 41, a portion of the electrode terminal is exposed to an outer surface of the adapter housing through a corresponding first through hole, and another portion is electrically connected to the main control circuit board.

14. The earphone according to claim 1, wherein the terminal assembly includes a detection terminal, the detection terminal facilitates the earphone to implement a detection function.

15. The earphone according to claim 5, wherein the first annular butting edge and the second annular butting edge are engaged through an interference fit.

16. The earphone according to claim 5, wherein a viscous medium is filled between opposing surfaces of the first annular butting edge and the second annular butting edge.

17. The earphone according to claim 8, wherein the stop block is opposite to the card slot in the length direction, a side of the stop block away from the card slot along the length direction abuts against the inner wall of the core housing.

18. The earphone according to claim 9, wherein the flange is provided with a stop block, the stop block passes through the interval channel and abuts against the inner wall of the core housing, and is engaged with the first annular butting edge.

19. The earphone according to claim 9, wherein the auxiliary connection portion includes the pressing area and a curved area, one side of the curved area is connected with the pressing area, and another side of the curved area is curved and extends toward an interior of the core housing along the thickness direction, the interval channel is formed between a portion of the first annular butting edge and the curved area.

20. The earphone according to claim 10, wherein the speaker assembly is disposed on a side of the auxiliary connection portion away from the auricle, a portion of the speaker assembly is placed on a side of the pressing area away from the adapter housing.
